(19) United States
(12) Patent Application Publication
(10) Pub. No.: US 2007/0039216 A1
(43) Pub. Date: Feb. 22, 2007

(54) Ornamental media device

(76) Inventor: Jeff Scarpitti, Columbus, OH (US)

Correspondence Address: Starkweather & Associates, Suite 200, 9035 South 1300 East, Sandy, UT, 84094, US

(21) Appl. No.: 11/205,897

(22) Filed: Aug. 16, 2005

(51) Int. Cl. G09F 3/04; G09F 9/37; A47G 35/00

(52) U.S. Cl. 40/447; 428/542.4; 40/463

(57) ABSTRACT

A record/playback module is incorporated into an ornamental article, such as a trophy, award, medallion, wall plaque, and the like. The record/playback module is suitably a microchip and batteries disposed in the case of the article. Various embodiments of switches for activating the device are disclosed, as well as techniques for disabling a recording feature of the device.

### BACKGROUND OF THE INVENTION

1. Field of the Invention

The present invention relates to ornamental articles, specifically to ornamental articles that include media devices.

2. Description of the Related Art

Although there are many various styles and designs of trophies, many of them are “generic” in nature. For example, there are trophies for bowling, football, baseball, tennis, golf, soccer, basketball, etc. The vast majority of these trophies have limited capability for customization/personalization, for example, allowing the recipient's name to be placed on a plaque which is incorporated onto the trophy or award. Typically, these trophies end up merely gathering dust on a shelf.

The present invention relates to incorporating a record/playback device in an ornamental article such as a trophy to add the dimension of sound to the article, as well as to further personalize the trophy.

There are many types of record/playback devices (or modules) on the market. One such device incorporates a microchip and a small piezoelectric audio transducer. Typically, the transducer operates only in the playback mode, the recorded message being electronically “burned into” the microchip during its final packaging. Examples of microchip-type record/playback devices can be found in U.S. Pat. Nos. 4,890,259; 4,989,179; 5,126,967; 5,164,915; and 5,220,531, all of which are incorporated in their entirety be reference herein.

Often, a requirement of a record/playback device is that it will not lose the recorded message in the event of a power failure or battery replacement. To this end, it is known to provide an auxiliary long life battery capable of preserving recorded data (i.e., the recorded message), or to record the message in non-volatile memory (NVM).

Many ornamental articles do not provide any sensory output other than color and texture. Further, many ornamental articles lack personalization. Ornamental articles may lack a record/playback module suitably incorporated into the base of the trophy. Another lacking option is the ability of a user to activate a “record” function of a record/playback device and record an appropriate personalized audio message for the intended recipient. Further, appropriate control of functions may be lacking.

What is needed is an ornamental device that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available ornamental devices. Accordingly, the present invention has been developed to provide an ornamental media device.

In one embodiment, there is an ornamental media device for preserving memories. An ornamental media device may include an ornamental display and/or a media module. An ornamental display may include a trophy, plaque, wall plaque, medallion, award, ornament, etc. A media module may include a record module, a storage module, a play module, and/or a preservation module. One or more modules may have one or more overlapping devices, structures, components, etc.

A record module may be configured to selectably record media information. Media information may include any information relating to sensory information. As non-limiting examples, media information may be audio, video, and the like and any combination thereof. A record module may be activated by a selection, such as but not limited to actuation or toggling of a button, switch, lever, plunger, etc.

A storage module may be configured to store recorded information. A storage module may comprise an integrated circuit, a magnetic storage device, a rewritable storage device, and any other information storage device or combinations thereof.

A play module may be configured to selectably play media information stored by the storage module. A play module may be configured to read information stored in the storage module and/or to accept a feed of information therefrom, directly or indirectly. A play module may be a speaker, a video display, a flip screen, a monitor, and the like.

A preservation module may be configured to actuatably disable the record module. Such may be accomplished by actuation of any device, structure, etc. that may altering, disrupting, destroying, interfering with, or otherwise disabling an ability of the record module to alter recorded information stored by the storage module.

In one embodiment a record module comprises a necessary element. A necessary element may be a member included in the media module that may be required for alteration of a state of the storage module, such that without such a recorded information set intended that may be played by the play module may not be significantly altered. In one non-limiting example, a necessary element may be a coupling between the record module and the storage module. In another non-limiting example, the necessary element may be a power supply to a recording device of the record and/or storage modules. There may be a preservation module that actuatably destroys the necessary element. For a non-limiting example, there may be a lever configured to break a circuit element when actuated.

In another embodiment, a preservation module comprises a necessary element of the record module. It may be that a necessary element is configured to be removed from the ornamental media device by actuation of the preservation module. In a non-limiting example, there may be a strip of conductive material that may electrically couple a pair of elements of the media module, such that removal of the strip of material, for example by a purchaser of the device, may disable the record module.

In one example, there may be a housing that may enclose a media module. A preservation module may comprise an aperture through the housing enclosure and/or may exposing a necessary element. Actuation of the preservation media may comprise insertion of a foreign object through the aperture. A foreign object may be graduated, sharpened, rigid, or otherwise capable of affecting a desired alteration of the media module. A foreign object may destroy the necessary element.

A preservation module may comprise a necessary element of the record module and/or the necessary element may be destroyed when exposed to an environmental effect. An environmental effect may include but is not limited to a severe temperature, a vibration, a physical shock, an electrical shock, an exposure to a solvent such as but not limited to water.

There may be a preservation module that may comprise a one-way alterable circuit configuration of the record module. As a non-limiting example, a one-way alterable circuit configuration may comprise insertion of a conductive module through a one-way aperture. In one non-limiting example, there may be a conductive slug that may be insertable through an aperture wherein the aperture may comprise a ratcheting mechanism, such that once inserted the slug may be restricted from exiting the aperture and/or wherein the slug may alter a circuit of the media module such that the record module is disabled.

In another embodiment, there may be an ornamental media device for presenting memories that may include an ornamental display and a media module. The media module may include a storage module configured to store video information and a play module configured to play video information stored by the storage module.

There may be a trophy to award to winners of a competition. The trophy may include a display portion and/or a media module. The display portion may be configured to resemble a sporting activity to which a person may be engaged. The media module may be coupled to the display portion and may be configured to enable audio recording, audio playing, and/or non-erasable storage of the audio recording. The display portion may be selected from the group consisting of: a baseball player, a hockey player, a soccer player, a race car, a bowler, a fisherman, a golfer, and a runner. The display portion may be configured to resemble a person engaged in a sporting activity.

A recipient's enjoyment of the trophy may be enhanced and the trophy may preserve for posterity the “actual moments” that the trophy was awarded to the recipient. Such trophies could easily become collectible items over time. Imagine having Michael Jordan's first high school basketball trophy or Garth Brooks accepting his Grammy award.

According to an embodiment of the invention, once the appropriate personalized message has been recorded on the record/playback device within the trophy, the record feature can be “deactivated” so that the recorded message cannot be altered or erased. A number of techniques for implementing this deactivation feature are described herein below.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view of a trophy of the prior art;

FIG. 2 is a schematic block diagram of a record/playback device of the prior art;

FIG. 3A is a perspective, cutaway view of a trophy with media device according to one embodiment of the invention;

FIG. 3B is a bottom view of the trophy with media device of FIG. 3A, according to one embodiment of the invention;

FIG. 4 is a side, cross-sectional partial view of a portion of an exemplary trophy with media device according to one embodiment of the invention, highlighting the plunger component of the record/playback module;

FIG. 5 is a side, cross-sectional partial view of a portion of an exemplary trophy with media device according to one embodiment of the invention, highlighting a record switch component of the record/playback module;

FIG. 6 is a schematic block diagram of a record/playback device according to one embodiment of the invention;

FIG. 7A is a perspective top view of a base according to one embodiment of the invention;

FIG. 7B is a perspective bottom view of the base of the ornamental device shown in FIG. 7A;

FIG. 7C is a cross-sectional view of a portion of the base of the ornamental device shown in FIG. 7A, according to one embodiment of the invention;

FIG. 7D is a plan view of a “pull tab” element shown in FIG. 7C; and

FIG. 7E is a cross-sectional view of a portion of the base of the ornamental article shown in FIG. 7A, according to one embodiment of the invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

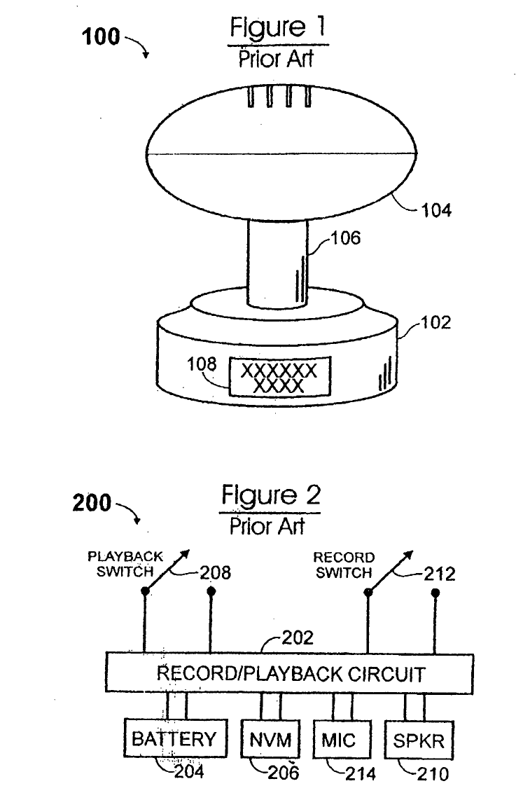

FIG. 1 illustrates a trophy 100 of the prior art. The trophy 100 has a base (pedestal) 102, an object 104 representative of the field of endeavor in which the trophy is awarded and, optionally, a standoff element (stalk) 106 which locates the object 104 at a distance above the base 102 of the trophy. In this example, the object 104 is a football, indicating that the trophy 100 was awarded for the recipient's (not shown) efforts incident to playing the athletic sport of football. Often, a plaque 108 is mounted to the trophy 100, such as on the pedestal 102, and is engraved with a personalized message which may indicate the recipient (e.g., “Joe”) and a sporting event (e.g., “Orange Bowl 1989”) for which the trophy is awarded.

FIG. 2 illustrates a record/playback device (module) 200 of the prior art. The record/playback device 200 comprises a record/playback circuit 202 which may be of the microchip-type referenced hereinabove. In a typical arrangement, the record/playback circuit 202 is powered by a battery 204 which may be replaceable or non-replaceable. A message is recorded (digitally encoded) in non-volatile memory (NVM) 206, which may either be a separate microchip or incorporated as a functional block on the chip of the record/playback circuit 202. A playback switch 208, for example a normally-open single-pole single-throw (SPST) pushbutton switch, is connected to the record/playback circuit 202. When the playback switch 208 is closed the message recorded in the NVM 206 will play back through a speaker 210 connected to the record/playback circuit 202. There may be a pause between closing the playback switch 208 and the playing through the speaker 210. The speaker 210 is suitably a piezoelectric audio transducer.

There are basically two ways to record a message on the record/playback device 200. One way to record the message on the record/playback device 200 is to “burn” the message into the NVM 210 (or equivalent data storage device or functional block) by injecting signals into contact pads (not shown) on the record/playback device 200. After recording the message in this manner, the record/playback device 200 is typically finally packaged, such as with glob-top epoxy which also covers the contact pads.

Another way to record the message on the record/playback device 200 is to close a switch 212, and speak into an audio transducer 214 functioning as a microphone. Closing the switch 212 activates a record feature of the device 200. The transducer 214 is suitably a piezoelectric audio transducer and may be implemented as the same transducer as the transducer 210, the function of the transducer as either a microphone or as a speaker being controlled in response to which of the two switches 212 and 208, respectively, are closed.

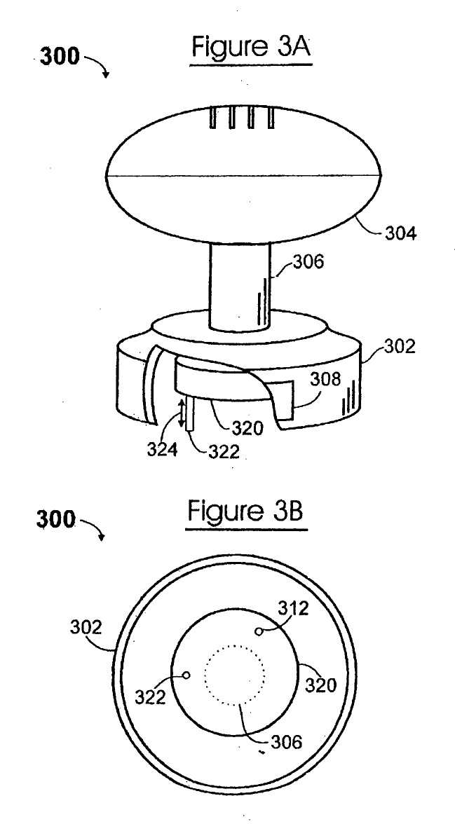

FIG. 3A illustrates an embodiment of the trophy with media device or media module 300 of the present invention. Comparable to the trophy 100 (described hereinabove with respect to FIG. 1) of the prior art, the trophy with media device 300 has a base (pedestal) 302 (compare 102), an object 304 (compare 104) representative of the field of endeavor in which the trophy is awarded and, optionally, a standoff element (stalk) 306 (compare 106) which locates the object 304 at a distance above the base 302 of the trophy with media device 300. In this, as in the previous example, the exemplary object 304 is a football, indicating that the trophy with media device 300 was awarded for the recipient's (not shown) efforts incident to playing the athletic sport of football. In this, as in the previous example, a plaque 308 (compare 108) is mounted to the pedestal 302.

The trophy with media device 300, such as but not limited to an annunciator/audio device and/or a video device, of the present invention is shown in a cutaway view in FIG. 3A, and is also shown in a bottom view in FIG. 3B. Therein it can be seen that a record/playback module 320 is disposed within the pedestal (housing) 302 of the trophy with media device 300. A spring-loaded plunger 322 extends out the bottom surface of the record/playback module 320 and is operatively connected (mechanically linked) to a playback switch (not shown, compare 208) described in greater detail herein below. In its extended position, the plunger 322 extends beyond the bottom edge of the pedestal 302 so that when the trophy with media device 300 is lifted up from a surface (not shown) upon which it is resting (e.g., off of a shelf or a table), it moves in a downward direction and operates the playback switch (described herein below) to a first position (i.e., to the “on” position). When the trophy with media device 300 is replaced onto the surface, the plunger 322 depresses, moving partially back into the record/playback module 320 and operating the playback switch (described herein below) to a second position (i.e., to an “off” position). This movement of the plunger 322 in and out of the record/playback module 320 is represented by the two-headed arrow 324. In this manner, a message recorded in the record/playback module 320 will play when the trophy with media device 300 is lifted from a surface upon which it is resting, and will cease playing when the trophy with media device 300 is returned to rest on the surface.

The term “switches”, as used herein, refers to an electronic device for turning associated electronic circuitry on and off, and includes reference to any “plunger” or comparable mechanical instrumentality which operates the switch.

The record/playback module can simply be a record/playback device (200) such as was described with respect to FIG. 2, made to fit within the pedestal 302 of the trophy with media device 300 and with a suitable plunger 322 operating the playback switch (208). The record switch (212) of such a record/playback device (200) can suitably be exposed on the bottom surface of the record/playback module 320, as shown by the button 312 visible in FIG. 3B on the bottom surface of the record/playback module 320. It is preferred that once a message is recorded, it becomes difficult (if not impossible) to alter or erase it. To this end, the switch 312 may be recessed behind an access hole (compare 516, below) in the record/playback module 320.

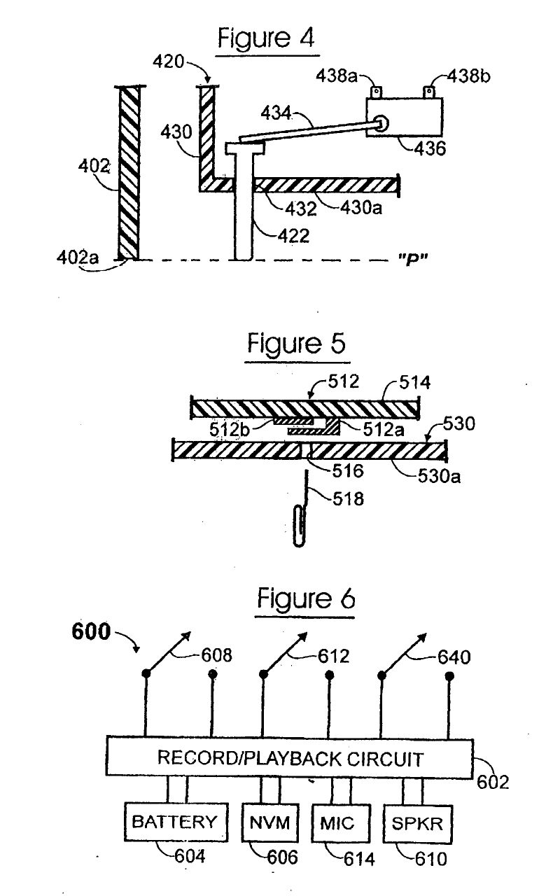

FIG. 4 illustrates an exemplary record/playback module 420 (compare 320) of the present invention, suitable for mounting within the pedestal (320) of a trophy with media device (300). In this figure, mechanical details of an exemplary arrangement of a plunger 422 (compare 322) and a playback switch 436 are illustrated. The record/playback module 420 has a housing 430 which is suitably made of injection-molded thermoplastic. A plunger 422 (compare 322) extends through a hole 432 in a bottom surface 430a of the housing 430, and is urged to an extended position by any suitable resilient means, such as a spring-loaded lever arm 434 of a switch 436 serving the function of a playback switch (compare 208). In its extended position (as shown) the plunger extends beyond a plane “P” of a bottom edge 402a of the pedestal 402 (compare 302) of the trophy with media device. In this manner, a record/playback device such as described hereinabove can be operated (caused to play a recorded message) simply by lifting up the trophy with media device (300) from a surface upon which it is resting, as described hereinabove. The switch 436 is suitably a conventional “microswitch” having two terminals 438a and 438b. As mentioned hereinabove, it is preferred that once a message is recorded, it becomes difficult (if not impossible) to alter or erase it.

FIG. 5 illustrates a bottom surface 530a (compare 430a) of a housing 530 (compare 430) for a record/playback module (compare 320, 420). In this example, a record switch 512 (compare 212) comprises a cantilevered contact 512a suspended above a contact pad 512b on an interconnection substrate 514 such as a printed circuit board (PCB) to which other components (not shown) of the record/playback device (compare 200) are mounted. The record switch 512 is disposed immediately behind a small (e.g., 1/16 inch diameter) hole 516 extending through the bottom surface 530a of the housing 530. In this manner, a small elongate instrument, such as the end of a partially straightened paperclip 518, can be inserted into the hole 516 to activate the record switch 512. To record a message, a user would insert the elongate instrument 518 into the hole 516 to activate the record switch 512, then remove the elongate instrument 518 at the completion of recording the message. In this manner, it would be difficult for the recorded message to be inadvertently altered or erased. To further ensure against inadvertent alteration or erasure of the recorded message, a dollop of epoxy (not shown) can be applied to the hole 516 after recording the message.

FIG. 6 illustrates another embodiment of the invention, wherein inadvertent alteration or erasure of, or mischievous tampering with a recorded message is reliably ensured. In this embodiment, alteration/erasure protection is electronically implemented, rather than mechanically implemented as in the embodiment of FIG. 5. The illustrated record/playback device 600 of the present invention is comparable to the record/playback device 200 of the prior art, described hereinabove.

The record/playback device 600 comprises a record/playback circuit 602 (compare 202) which may be of the microchip-type referenced hereinabove, and is typically powered by a battery 604 (compare 204). A message is recorded using any suitable means such as a microphone 614 (compare 214) in non-volatile memory (NVM) 606 (compare 206). A playback switch 608 (compare 208, 436) is connected to the record/playback circuit 602. When the playback switch 608 is closed, the message recorded in the NVM 606 will playback through a speaker 610 (compare 210) connected to the record/playback circuit 602, as described hereinabove. In this example, recording is initiated (a record feature is activated) by closure of a record switch 612 (compare 212, 512).

In order to ensure inadvertent alteration or erasure of, or mischievous tampering with a recorded message, a third switch 640 is provided. This switch 640 can be arranged like the record switch 512—in other words, behind a hole in the housing of the record/playback module. The function of the switch 640 is to set a “bit” in the NVM 606 which will disable the record function. Thus, once a message is recorded, the user would depress the switch 640, and the message could not be recorded over. One having ordinary skill in the art to which the present invention most nearly pertains will readily appreciate how to implement such a “block-out” function in logic simply by setting a “bit”.

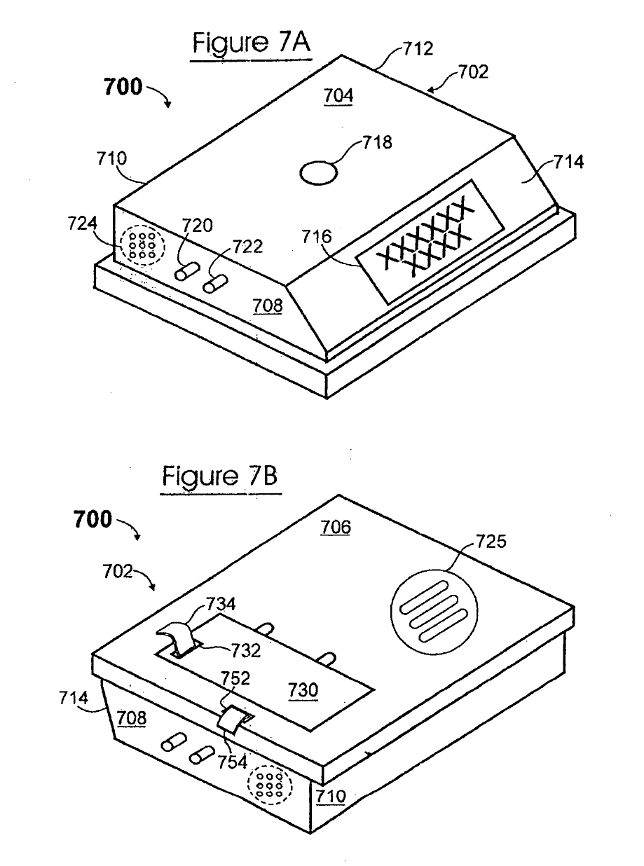

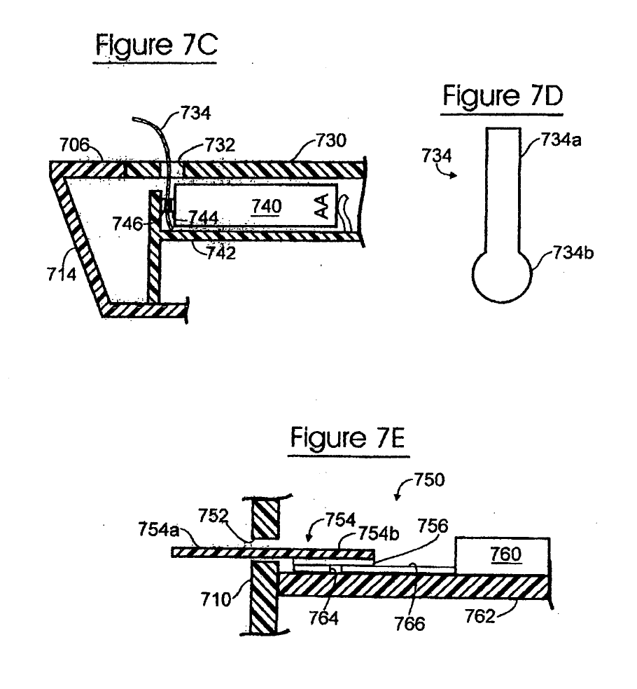

FIGS. 7A and 7B illustrate an alternate embodiment of an ornamental article 700 (compare 300) having a base 702 (compare pedestal 302). The base is a housing having a top surface 704, a bottom surface 706, a side surface 708, a back surface 710, another side surface 712, and a front surface 714. As illustrated, the front surface 714 is beveled (angled), and a plaque 716 (compare 308) is mounted to the front surface 714. A hole 718 is shown extending through the top surface 704 of the housing 702 for mounting an object (not shown, compare 302).

Two buttons (or plungers) 720 and 722 (compare 312, 322) extend through the side surface 708 from within the housing 702 so that switches (not shown, compare record switch 212 and playback switch 208) disposed within the housing 702 can be operated from external the housing 702 without lifting the article 700.

A speaker (not shown, compare 210) is suitably disposed inside the housing 702, and a plurality of openings 724 may be provided through the side surface 708 to facilitate sound exiting the housing 702. It is also within the terms of the invention to include a second plurality of openings 725 to facilitate sound exiting housing 702. Preferably, the speaker faces a bottom 706 such that sound may exit through openings 725. Advantageously, sound exiting through the bottom 706 may cause resonance in a surface upon which the article may rest.

As best viewed in FIG. 7B, an access door 730 is provided in the bottom surface 706 of the housing 702. This door 730 is of the type that allows for access to batteries (not shown) disposed within the housing 702, for installing and/or replacing the batteries.

A slot 732 is provided in the access door 730. A tape or ribbon 734 extends from within the housing 702, through the slot 732 in the access door 720. The purpose of the tape 734 is described with respect to FIG. 7C.

FIG. 7C illustrates an optional feature of the invention. As shown therein, the tape 734 extends through the slot 732 in the access door 730 from the exterior of the housing (atop the door 730, as viewed) to within the housing (below the door 730, as viewed). One or more batteries 740 are disposed within the housing (702) within a battery-receiving bracket 742. Only one of these batteries is illustrated, however it is within the terms of the invention to incorporate any desired number of batteries, as needed. As illustrated, an end portion of the tape 734 extends between a terminal 744 on the end of the battery 740 and a corresponding terminal 746 on the bracket 742. In this manner, current will not flow (from the battery to the circuit) until the tape 734 is removed. The tape 734 is of an insulating material, such as mylar, to prevent electricity from flowing between the terminals 744 and 746 when the battery is in place there between. FIG. 7D is a plan view of the tape 734, showing that it is elongate, having a one end 734a and an opposite end 734b. The tape 734 is referred to as a “pull tab”, and its purpose is to turn on the power to the record/playback module (activate the module) when the pull tab is pulled. The pull tab 734 may be discarded once the module is activated.

As mentioned hereinabove, it is desirable to be able to disable the record feature once a satisfactory message has been recorded. A mechanism 750 for disabling the record feature is shown in FIGS. 7E and 7B, as described below.

A slot 752 (compare the slot 732) is provided in the bottom surface 706 of the housing 702. An elongate tape or ribbon 754 (compare 734) extends from within the housing 702, through the slot 752 so that a portion 754a of the tape 754 is external the housing 702 and an opposite portion of the tape 754 is internal the housing 702. The tape 754 is suitably made of an insulating material such as mylar. As illustrated, the internal end portion 754b of the tape 754 is provided with a metallized, electrically-conductive film or layer 756.

The record/playback module 760 (compare 200) is mounted to a printed circuit board 762. As is known, printed circuit boards are insulating substrates with conductive metallic traces on a surface thereof. As illustrated herein, the metallized portion 756 of the tape 754 bridges a gap between two conductive traces 764 and 766 on the printed circuit board 762. A suitable biasing means, such as a plastic tab (not shown) may be provided in order to ensure physical contact between the conductive material 756 and the traces 764 and 766. In this manner, a circuit is completed, for example, a circuit (discussed hereinabove) for activating a record feature on the record/playback module 760. Upon removing the tape 754, the record circuit is permanently disabled. It can be seen that the conductive portion 756 of the tape 754 acts as a normally-closed (NC) switch connected in series with the normally-open (NO) record switch 612, so as to disable the record function when removed.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

For example, in one embodiment, there is an ornamental media device for preserving memories. An ornamental media device may include an ornamental display and/or a media module. An ornamental display may include a trophy, plaque, wall plaque, medallion, award, ornament, mirror, bobble doll, hat, ornamental kitchen device, pet collar, ornamental computer peripheral such as a mouse, drink holders, and the like. A media module may include a record module, a storage module, a play module, and/or a preservation module. One or more modules may have one or more overlapping devices, structures, components, etc.

A record module may be configured to selectably record media information. Media information may include any information relating to sensory information. As non-limiting examples, media information may be audio, video, and the like and any combination thereof. A record module may be activated by a selection, such as but not limited to actuation or toggling of a button, switch, lever, plunger, etc.

A storage module may be configured to store recorded information. A storage module may comprise an integrated circuit, a magnetic storage device, a rewritable storage device, and any other information storage device or combinations thereof.

A play module may be configured to selectably play media information stored by the storage module. A play module may be configured to read information stored in the storage module and/or to accept a feed of information therefrom, directly or indirectly. A play module may be a speaker, a video display, a flip screen, a monitor, and the like.

A preservation module may be configured to actuatably disable the record module. Such may be accomplished by actuation of any device, structure, etc. that may altering, disrupting, destroying, interfering with, or otherwise disabling an ability of the record module to alter recorded information stored by the storage module.

In one embodiment a record module comprises a necessary element. A necessary element may be a member included in the media module that may be required for alteration of a state of the storage module, such that without such a recorded information set intended that may be played by the play module may not be significantly altered. In one non-limiting example, a necessary element may be a coupling between the record module and the storage module. In another non-limiting example, the necessary element may be a power supply to a recording device of the record and/or storage modules. There may be a preservation module that actuatably destroys the necessary element. For a non-limiting example, there may be a lever configured to break a circuit element when actuated.

In another embodiment, a preservation module comprises a necessary element of the record module. It may be that a necessary element is configured to be removed from the ornamental media device by actuation of the preservation module. In a non-limiting example, there may be a strip of conductive material that may electrically couple a pair of elements of the media module, such that removal of the strip of material, for example by a purchaser of the device, may disable the record module.

In one example, there may be a housing that may enclose a media module. A preservation module may comprise an aperture through the housing enclosure and/or may exposing a necessary element. Actuation of the preservation media may comprise insertion of a foreign object through the aperture. A foreign object may be graduated, sharpened, rigid, or otherwise capable of affecting a desired alteration of the media module. A foreign object may destroy the necessary element.

A preservation module may comprise a necessary element of the record module and/or the necessary element may be destroyed when exposed to an environmental effect. An environmental effect may include but is not limited to a severe temperature, a vibration, a physical shock, an electrical shock, an exposure to a solvent such as but not limited to water.

There may be a preservation module that may comprise a one-way alterable circuit configuration of the record module. As a non-limiting example, a one-way alterable circuit configuration may comprise insertion of a conductive module through a one-way aperture. In one non-limiting example, there may be a conductive slug that may be insertable through an aperture wherein the aperture may comprise a ratcheting mechanism, such that once inserted the slug may be restricted from exiting the aperture and/or wherein the slug may alter a circuit of the media module such that the record module is disabled.

In another embodiment, there may be an ornamental media device for presenting memories that may include an ornamental display and a media module. The media module may include a storage module configured to store video information and a play module configured to play video information stored by the storage module.

There may be a trophy to award to winners of a competition. The trophy may include a display portion and/or a media module. The display portion may be configured to resemble a sporting activity to which a person may be engaged. The media module may be coupled to the display portion and may be configured to enable audio recording, audio playing, and/or non-erasable storage of the audio recording. The display portion may be selected from the group consisting of: a baseball player, a hockey player, a soccer player, a race car, a bowler, a fisherman, a golfer, and a runner. The display portion may be configured to resemble a person engaged in a sporting activity.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. An ornamental media device for preserving memories, comprising:
an ornamental display; and
a media module, coupled to the ornamental display, including:
a record module configured to selectably record media information;
a storage module configured to store the media information; and
a play module configured to selectably play the media.

2. The ornamental media device of claim 1, further comprising a preservation module configured to actuatably disable the record module.

3. The ornamental media device of claim 2, wherein the preservation module comprises a necessary element of the record module, which necessary element is configured to be removed from the ornamental media device by actuation of the preservation module.

4. The ornamental media device of claim 2, further comprising a housing enclosing the media module, wherein the preservation module comprises an aperture through the housing enclosure exposing a necessary element, and wherein actuation of the preservation media comprises insertion of a foreign object through the aperture, thereby destroying the necessary element.

5. The ornamental media device of claim 2, wherein the preservation module comprises a necessary element of the record module and wherein the necessary element is destroyed when exposed to an environmental effect.

6. The ornamental media device of claim 2, wherein the preservation module comprises a one-way alterable circuit configuration of the record module.

7. The ornamental media device of claim 1, wherein the play module comprises configured to play video.

8. The ornamental media device of claim 1, wherein the play module comprises configured to play audio.

9. The ornamental media device of claim 6, wherein the one-way alterable circuit configuration comprises insertion of a conductive module through a one-way aperture.

10. The ornamental media device of claim 5, wherein the environmental effect comprises a severe temperature.

11. The ornamental media device of claim 2, wherein the record module comprises a necessary element and wherein the preservation module actuatably destroys the necessary element.

12. An ornamental media device for presenting memories, comprising:
an ornamental display;
a media module coupled to the ornamental display, including:
a storage module configured to store video information; and
a play module configured to selectably play video information stored by the storage module.

13. A trophy to award to winners of a competition, comprising:
a display portion configured to resemble a sporting activity to which a person may be engaged; and
a media module, coupled to the display portion, configured to enable audio recording, audio playing, and non-erasable storage of the audio recording.

14. The trophy of claim 13, wherein the display portion is selected from the group consisting of: a baseball player, a hockey player, a soccer player, a race car, a bowler, a fisherman, a golfer, and a runner.

15. The trophy of claim 13, wherein the media module is configured to resemble a person engaged in a sporting activity.
